(19) United States
(12) Patent Application Publication
(10) Pub. No.: US 2003/0113422 A1
(43) Pub. Date: Jun. 19, 2003

(54) Method of producing meat portions

(75) Inventors: Petra Groneberg-Nienstedt, Haltern (DE); Jorg Rosenberger, Reken (DE)

Correspondence Address: THE FIRM OF KARL F ROSS, 5676 RIVERDALE AVENUE, PO BOX 900, RIVERDALE (BRONX), NY, 10471-0900, US

(73) Assignee: NIENSTEDT GMBH

(21) Appl. No.: 10/318,313

(22) Filed: Dec. 12, 2002

(30) Foreign Application Priority Data
Dec. 14, 2001 (DE) 10164637.2

(51) Int. Cl. A01J 1/00

(52) U.S. Cl. 426/513

(57) ABSTRACT

Pieces of meat deep frozen to −5° C. to −20° C. in unit volumes and weight and without significant distortion of the muscle fiber structure are pressed in a mold to serving size portions in which the muscle structure is retained. The equal weight identical serving size portions can thus be automatically cooked for identical time periods and at identical temperature.

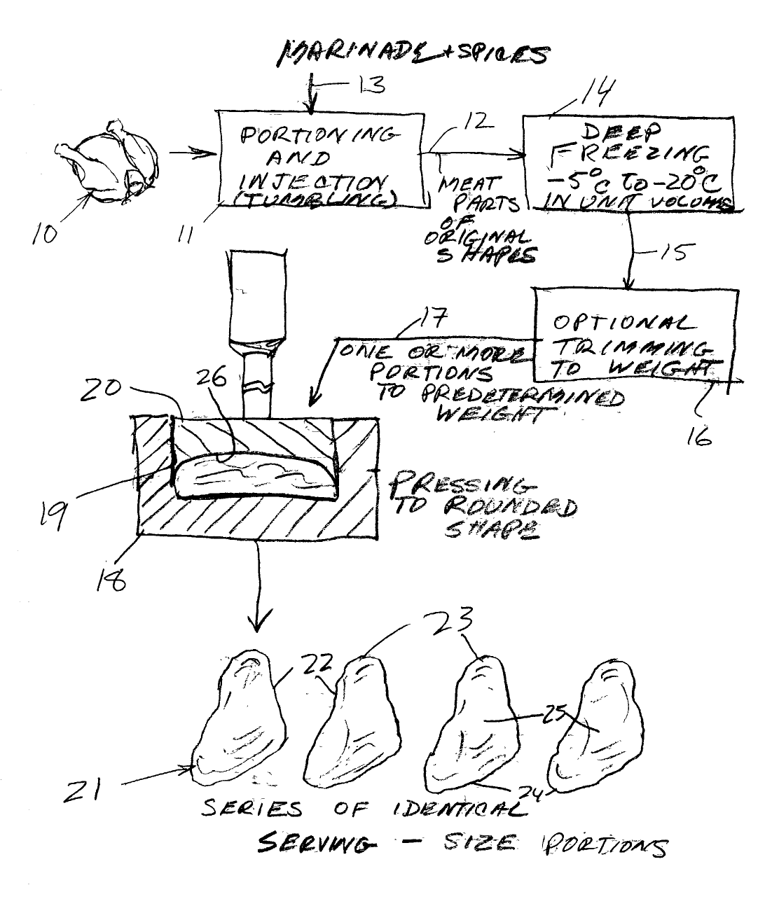

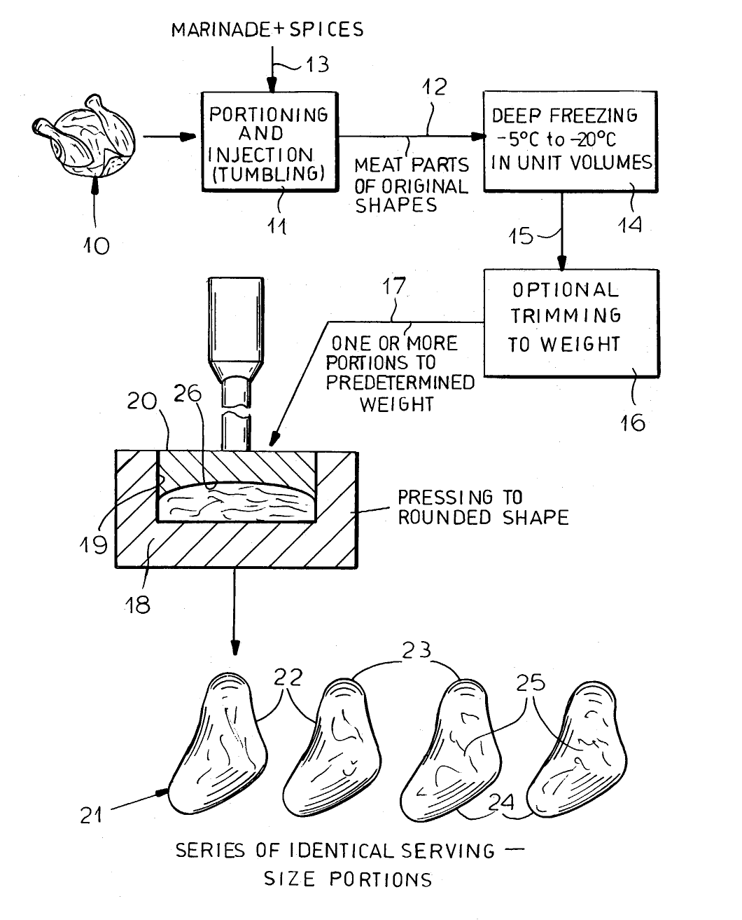

### SPECIFICATION

### Field of the Invention

Our present invention relates to a method of producing meat portions and, more particularly, to a method of producing equal-weight portions of meat of an identical shape.

### Background of the Invention

The food industry desires meat portions which are substantially homogeneous in their properties, are of uniform size, and can be of uniform shape so that they can be identically cooked for a preset time and under preset conditions. The meat portions thus can be cooked identically and automatically. Most frequently the desire is to provide such meat portions that they are of a serving size and therefore of relatively large size or cross section.

It is known to freeze blocks of meat and to saw them into rectangular prismatic pieces and then to take these pieces and to press them into shape. However, because the pieces of meat are first transformed into rectangular prismatic configurations, the pressing of them into shape usually results in a major deformation. This is especially the case if the pressed product is to have a rounded configuration which conforms to a natural shape of a food product. As a result of the freezing of the meat into a block form, the sawing of it into rectangular prismatic pieces and the pressing of these pieces into a rounded shape, the muscle fibers in the meat assume unnatural orientations and the meat product may have an undesirable fiber structure.

The term “meat” as used herein is intended to refer to not only animal meats like poultry, cattle, pork or lamb and mutton, but also fish meat and sea foods generally.

### OBJECTS OF THE INVENTION

It is, therefore, the principal object of the present invention to provide a method which overcomes the drawbacks of the earlier systems mentioned and which is able to provide highly reproducible serving size meat portions with an improved fiber structure for all of the meat sources mentioned.

Another object of the invention is to provide a method of making equal weight portions of meat from meat products of different starting configurations which are of identical shape, have shape stability to enable them to be cooked uniformly and identically and with fiber structures that largely match the fiber structures of the starting meat product.

The term “meat products” here of course, refers to any of the meat sources mentioned including poultry, cattle, pork, lamb or mutton as well as fish.

### SUMMARY OF THE INVENTION

These objects are attained, in accordance with the invention in that individual pieces of meat which have their natural shape and to which no other piece of meat is adherent are so cut or trimmed in a frozen or nonfrozen state that they have a desired weight and preferably a desired crude shape which, in the frozen state, is placed in a mold and pressed to the configuration of the mold and thus into a preferably serving size portion which can correspond generally in shape to a natural serving size. More particularly, therefore, a method of producing equal weight portions of meat of identical shape can comprise the steps of:

(a) cutting meat into pieces of a natural shape;

(b) freezing the pieces to produce frozen pieces of meat of natural shape;

(c) introducing a quantity of the frozen pieces corresponding to a given weight into a mold and pressing the meat in the mold to a final configuration defined by the mold while the meat is frozen; and

(d) repeating step (c) to produce a multiplicity of equal-weight portions of meat of identical shape.

According to the invention, a single frozen piece of meat is introduced into the mold in step (c) without any other piece of meat adhering thereto although the invention also includes introducing at lest one other frozen piece of the meat into the mold in step (c) prior to the pressing and without any other piece of meat adhering thereto.

Although the invention also includes introducing at least one other frozen piece of the meat into the mold in step (c) prior to the pressing and without any other piece of meat adhering thereto the two or more pieces of meat, although cut so that the mold holds the precise weight of the finished portions desired, are in close to their natural shapes and thus have a minimum of muscle fiber distortion and are so pressed together in the frozen state that the finished portion which results has structural integrity in that it does not separate and a fiber structure which corresponds to that of the natural piece or pieces used. The equal weight portions of meat which are obtained thus not only have the same weight but the same shape and density so that their muscle fiber structures are largely retained and hence the texture of the piece of meat in the eating corresponds to that of the natural meat product. Because all of the portions produced are of the same thickness and cross section, the cooking times are identical and shapes can be chosen so that the portions are of serving size and hence have relatively large cross sections. In principle the specific shape can be optional.

When two or more pieces of meat are pressed together in the mold to the final shape, all of the pieces bond together so firmly that even smaller pieces of meat can be used economically and there is no danger of separation.

Preferably the pieces of meat are introduced into the mold at a temperature of −5° C. to −20° C. It has been found to be advantageous further to provide the pieces of meat before they are pressed and/or cut or trimmed to weight, with a treatment with spices, pickles, sauces or marinades by immersion (soaking) injection and/or tumbling.

More specifically, muscle meat from an animal such as poultry, beef, pork, lamb or fish is frozen in its natural form. The term “natural form” is here used to mean that the piece of meat need not be pressed, cut or sawn to an extent that its original shape of the muscular structure is no longer recognizable. That of course is the case when meat is pressed into blocks and rectangular prismatic pieces are sawn therefrom.

The deep frozen pieces of meat are placed in the trough of a mold which has a greater length than width and a smaller height than its width and which has rounded corners so that one end or the other end have rounded shapes or both ends are rounded. The trough or mold can have generally the configuration of the natural shape of a piece of muscle meat with a slightly convex or concave upper or lower surface as is the case with marketable serving size portions of meat.

Once the piece of meat of a given weight or the two or more pieces of meat of that weight are positioned in the mold, a ram is pressed into the mold and applies a pressure to the meat which presses the latter sufficiently to ensure that the meat fills the mold and assumes the shape thereof. The muscle fibers can be somewhat shifted during the pressing but largely retain the shape of the natural piece of pieces introduced into the mold. The resulting portion is thus shape stable.

As noted the temperature at which the pressing is effected is preferably −5° C. to −20° C. and the pressing can be carried out in the manner described in German patent documents DE 198 06 391 A1 or DE 197 32 206 C 1.

The introduction of the pieces of meat into the mold or trough can be effected manually or automatically. The method does not depend upon a special geometry of the starting material as is the case, for example, when deep-frozen blocks are sawn into rectangular parallelopipedal pieces (see U.S. Pat. No. 6,210,733). As a consequence a special preforming step prior to providing the pieces which are to be introduced into the mold and to have the desired end configuration is not required. It is only necessary to divide the natural meat into portions which, as a single piece or as two or more pieces, have the desired weight and natural fiber orientation and structure and to insert these in a frozen state into the mold or trough. The cross section of the piece or pieces to be introduced into the mold should not exceed the trough cross section. The pieces of meat can be frozen under geometric restrictions, for example, in suitable containers, so that the frozen units can then be introduced into the mold, it being noted that no pressing is required to form the frozen pieces. The starting portions, therefore, can be frozen under atmospheric pressure.

The pieces of meat which are produced with the desired shape and in equal weight portions are formed from a single piece introduced into the mold or by assembly of two or more pieces which are arranged together under pressure. Preferably they are large pieces in the sense that they are serving-size portions. The meat pieces prior to introduction into the mold can be untreated or can be previously treated by seasoning or marination with appropriate food additives. The pretreatment may involve marination, injection or tumbling or combinations thereof.

Before the pieces of meat are placed in the mold, they can be cut to the desired weight or desired volume for the serving size portion to be produced. As a rule the cutting should involve trimming of the edges only to maintain as much as possible the meat in its natural muscle fiber form.

### BRIEF DESCRIPTION OF THE DRAWING

The above and other objects, features and advantages of the present invention will become more readily apparent from the following description, reference being made to the accompanying drawing, the sole FIGURE of which is a flow diagram illustrating the method and the specific example which is the application of the invention to poultry meat in the production of split breast serving size portions of chicken.

### SPECIFIC DESCRIPTION

As can be seen in the drawing, the starting unit is the meat in its natural shape or form here represented by a chicken carcass 10 which has not been unsubdivided into parts. That starting unit can be beef, lamb or pork and the meat is portioned at 11 into meat parts of their original shapes at 12. Step 11 can include the injection, immersion or assembling of the meat parts with marinades, pickles or spices which can be introduced at 13. The meat parts in their original shapes and thus without material alteration of the muscle fibers, i.e. without pressing, are deep-frozen at 14 in unit volumes corresponding to the volume necessary under pressing to produce serving size portions. The unit volumes may be a single piece of meat or two or more pieces as has been noted and the deep freezing produces deep frozen units at 15 at a temperature of −5° C. to −20° C.

While normally that unit volume does not require trimming to weight, such trimming along the edges of the pieces may be effected at 16 to the desired weight of the serving size portions to be produced. Step 16 can alternatively precede the freezing step 14.

Each portion with the predetermined weight is then introduced into the mold at 17. The mold 18 has rounded edges corresponding to the rounded edges of the serving size portions to be produced and a cavity 19 dimensioned to shape the serving size portions. The mold is closed by a ram 20 which presses the meat to a rounded shape without materially altering the fiber orientation or muscle structure. The result is a series 21 of identical serving size portions 22, for example in a natural shape of the type of meat to be produced, for example, split chicken breasts, which are rounded at their ends 23 and 24, are somewhat convex on at least one surface 25 and have the same weight, the same size and the same muscle fiber structure so that they can be automatically cooked, e.g. broiled, fried or roasted, in an automated manner or identical cooking times.

When a ram 20 is used to shape for example chicken pieces, the underside 26 thereof can be slightly concave or domed to shape the surface of each portion 22 with a convex configuration. When two or more pieces of meat are introduced into the mold, they are pressed together and retain the cohesion of the serving size portion through cooking.

Instead of chicken, other meat types like beef, pork, mutton or fish can be used.

We claim:

1. A method of producing equal-weight portions of meat of identical shape, comprising the steps of:
(a) cutting meat into pieces of a natural shape;
(b) freezing said pieces to produce frozen pieces of meat of natural shape;
(c) introducing a quantity of said frozen pieces corresponding to a given weight into a rounded mold and pressing the meat in said mold to a final configuration defined by said mold while the meat is frozen; and
(d) repeating step (c) to produce a multiplicity of equal-weight portions of meat of identical shape.

2. The method defined in claim 1 wherein a single frozen piece of the meat is introduced into said mold in step (c) without any other pieces of meat adhering thereto.

3. The method defined in claim 2 wherein at least one other frozen piece of the meat is introduced into the mold in step (c) prior to pressing and without any other pieces of meat adhering thereto.

4. The method defined in claim 3 wherein said pieces of meat are introduced into said mold at a temperature of −5° C. to −20° C.

5. The method defined in claim 4, further comprising the step of treating said meat prior to pressing with at least one substance selected from the group which consists of sauces, spices, pickles and marinades.

6. The method defined in claim 5 wherein the treatment of the meat prior to pressing with said substance is effected at least in part by injection.

7. The method defined in claim 5 wherein the treatment of the meat prior to pressing with said substance is effected at least in part by tumbling.

8. The method defined in claim 5 wherein the treatment of the meat prior to pressing with said substance is effected at least in part by immersion.

9. The method defined in claim 5 wherein the treatment of the meat prior to pressing with said substance is effected prior to freezing.

10. The method defined in claim 5 wherein the treatment of the meat prior to pressing with said substance is effected prior to cutting.

11. The method defined in claim 1 wherein said pieces of meat are introduced into said mold at a temperature of −5° C. to −20° C.

12. The method defined in claim 1, further comprising the step of treating said meat prior to pressing with at least one substance selected from the group which consists of sauces, spices, pickles and marinades.

13. The method defined in claim 12 wherein the treatment of the meat prior to pressing with said substance is effected at least in part by injection.

14. The method defined in claim 12 wherein the treatment of the meat prior to pressing with said substance is effected at least in part by tumbling.

15. The method defined in claim 12 wherein the treatment of the meat prior to pressing with said substance is effected at least in part by immersion.

16. The method defined in claim 12 wherein the treatment of the meat prior to pressing with said substance is effected prior to freezing.

17. The method defined in claim 12 wherein the treatment of the meat prior to pressing with said substance is effected prior to cutting.
